(19) United States
(12) Patent Application Publication
(10) Pub. No.: US 2017/0272321 A1
(43) Pub. Date: Sep. 21, 2017

(54) CLOUD COMPUTING CONFIGURATION FORM GENERATOR

(71) Applicant: CloudBolt Software Inc., Campbell, CA (US)

(72) Inventors: Alexandre Augusto Ramos da Rocha, Rockville, MD (US); Thomas C. Hamlin, Portland, OR (US)

(21) Appl. No.: 15/254,692

(22) Filed: Sep. 1, 2016

Related U.S. Application Data
(60) Provisional application No. 62/310,762, filed on Mar. 20, 2016.

(51) Int. Cl. H04L 12/24

(52) U.S. Cl. CPC H04L 41/0816; H04L 41/0856

(57) ABSTRACT

Provided are examples of cloud computing form generators which enable data-driven configuring of cloud computing resources. A configuration form is generated, for example, by an administrator, based at least in part on computing resources available from two or more disparate computing clouds and preconfiguring objects available from the two or more disparate computing clouds. A subsequent cloud user (a “user”) can select one or more preconfigured objects and a candidate cloud from the configuration form. Then, computing resource attributes are automatically determined, based on the selected cloud and the selected preconfigured objects. The computing resource attributes can be translated into application program interfaces (APIs) appropriate for the selected cloud, and the APIs can be called from the selected cloud to implement the selected preconfigured objects.

### CLAIM OF PRIORITY

The present application for patent claims priority to U.S. Provisional Patent Application No. 62/310,762 entitled “CLOUD COMPUTING CONFIGURATION FORM GENERATOR”, filed Mar. 20, 2016, and assigned to the assignee hereof and hereby expressly incorporated by reference herein.

### FIELD OF DISCLOSURE

This disclosure relates generally to electronics, and more specifically, but not exclusively, to methods and apparatus which relate to cloud computing configuration form generators.

### BACKGROUND

Disparate cloud computing platforms offered by different cloud service providers have differing respective configuration formats for a similar object. Thus, conventional methods and apparatus for preparing a configuration template (which includes a combination of computing resources available from different cloud computing platforms offered by different cloud service providers) are complicated and time-consuming.

### SUMMARY

This summary provides a basic understanding of some aspects of the present teachings. This summary is not exhaustive in detail, and is neither intended to identify all critical features, nor intended to limit the scope of the claims.

Example methods and apparatus relating to cloud computing configuration form generators are disclosed. An example method includes discovering a plurality of computing resource attributes of respective computing resources. The computing resources are available from at least one of a first platform and a second platform. The example method also includes receiving data describing a limited group of computing resource attributes. The limited group of computing resource attributes includes one or more computing resource attributes in the plurality of computing resource attributes, and the limited group of computing resource attributes does not include all computing resource attributes in the plurality of computing resource attributes. The example method also includes generating a configuration form describing the limited group of computing resource attributes, enabling selecting one or more computing resource attribute from the limited group of computing resource attributes, and displaying, with a video display, the configuration form. The example method can also include displaying, with the video display: one or more descriptions of at least a portion of the plurality of computing resource attributes, one or more descriptions of one or more candidate limited groups of at least a portion of the plurality of the computing resource attributes, or a combination thereof. In an example, contents of the configuration form are dependent upon a group identifier, a logical grouping of computing resource attributes, or both. In an example, the limited group of computing resource attributes includes one or more device configuration parameters. In an example, the one or more device configuration parameters are limited to a set of options, are constrained by a minimum value, are constrained by a maximum value, include one or more regular expressions, are unconstrained, are hidden from display if the one or more device configuration parameters has a single value, are required, are optional, include an expiration date for an environment, or a practicable combination thereof. The example method can also include receiving data indicating a selection of a selected computing resource attribute from the configuration form, and adding the selected computing resource attribute to a list of selected service items. The service items include instructions configured to control a computing device. In an example, the list of selected service items includes information describing: configuration details of a server, configuration details of a virtual network, configuration details of an operating system, configuration details of software, configuration details of an object, configuration details of a cluster, configuration details of a network, a server deployment, a remote script configured to be run on a server, instructions configured to initiate deploying a pod of containers, instructions configured to initiate a networking change, instructions configured to initiate deploying a virtual network, instructions configured to initiate deploying a load balancer, instructions configured to initiate emailing a user, instructions configured to initiate coupling a virtual network to an external system, instructions configured to initiate performing an automatable operation, an internet protocol address, or a combination thereof. In an example, the data indicating the selection of the selected computing resource attribute includes data indicating a parameter value. The example method can also include translating at least a portion of the list of selected service items to one or more respective application programming interfaces (APIs) of the first platform, the second platform, or both. The APIs are configured to implement one or more selected service items in the list of selected service items. The example method can also include receiving an instruction to implement the one or more selected service items, and calling, via a communications network device, the APIs. The example method can also include receiving data indicating a deselection of a selected computing resource attribute from the configuration form, and removing the deselected service item from a list of selected service items. The example method can also include saving the limited group of computing resource attributes, retrieving the limited group of computing resource attributes from an electronic memory device, or both. The example method can also include saving the configuration form, retrieving the configuration form from an electronic memory device, or both. In an example, the configuration form is workload-specific, application-specific, or both.

In a further example, provided is a non-transitory computer-readable medium, comprising processor-executable instructions stored thereon. The processor-executable instructions can be configured to cause a processor to execute one or more parts of the aforementioned method. The processor-executable instructions can be configured to cause a processor to initiate executing one or more parts of the aforementioned method.

In another example, provided is a first apparatus. The first apparatus includes means for discovering a plurality of computing resource attributes of respective computing resources. The computing resources are available from at least one of a first platform and a second platform. The first apparatus also includes means for receiving data describing a limited group of computing resource attributes. The limited group of computing resource attributes includes one or more computing resource attributes in the plurality of computing resource attributes, and the limited group of computing resource attributes does not include all computing resource attributes in the plurality of computing resource attributes. The first apparatus also includes means for generating a configuration form describing the limited group of computing resource attributes, means for enabling selecting one or more computing resource attribute from the limited group of computing resource attributes, and means for displaying, with a video display, the configuration form. The first apparatus can also include means for displaying, with the video display: one or more descriptions of at least a portion of the plurality of computing resource attributes, one or more descriptions of one or more candidate limited groups of at least a portion of the plurality of the computing resource attributes, or a combination thereof. In an example, contents of the configuration form are dependent upon a group identifier, a logical grouping of computing resource attributes, or both. In an example, the limited group of computing resource attributes includes one or more device configuration parameters. In an example, the one or more device configuration parameters are limited to a set of options, are constrained by a minimum value, are constrained by a maximum value, include one or more regular expressions, are unconstrained, are hidden from display if the one or more device configuration parameters has a single value, are required, are optional, include an expiration date for an environment, or a practicable combination thereof. The first apparatus can also include means for receiving data indicating a selection of a selected computing resource attribute from the configuration form, and means for adding the selected computing resource attribute to a list of selected service items. The service items include instructions configured to control a computing device. In an example, the list of selected service items includes information describing: configuration details of a server, configuration details of a virtual network, configuration details of an operating system, configuration details of software, configuration details of an object, configuration details of a cluster, configuration details of a network, a server deployment, a remote script configured to be run on a server, instructions configured to initiate deploying a pod of containers, instructions configured to initiate a networking change, instructions configured to initiate deploying a virtual network, instructions configured to initiate deploying a load balancer, instructions configured to initiate emailing a user, instructions configured to initiate coupling a virtual network to an external system, instructions configured to initiate performing an automatable operation, an internet protocol address, or a combination thereof. In an example, the data indicating the selection of the selected computing resource attribute includes data indicating a parameter value. The first apparatus can also include means for translating at least a portion of the list of selected service items to one or more respective APIs of the first platform, the second platform, or both. The APIs are configured to implement one or more selected service items in the list of selected service items. The first apparatus can also include means for receiving an instruction to implement the one or more selected service items, and means for calling, via a communications network device, the APIs. The first apparatus can also include means for receiving data indicating a deselection of a selected computing resource attribute from the configuration form, and means for removing the deselected service item from a list of selected service items. The first apparatus can also include means for saving the limited group of computing resource attributes, means for retrieving the limited group of computing resource attributes from an electronic memory device, or both. The first apparatus can also include means for saving the configuration form, means for retrieving the configuration form from an electronic memory device, or both. In an example, the configuration form is workload-specific, application-specific, or both.

In another example, provided is a second apparatus. The second apparatus includes a processor and a memory coupled to the processor. The memory is configured to cause the processor to initiate creating specific logic circuits within the processor. The specific logic circuits are configured to cause the processor to initiate discovering a plurality of computing resource attributes of respective computing resources. The computing resources are available from at least one of a first platform and a second platform. The specific logic circuits are configured to cause the processor to initiate receiving data describing a limited group of computing resource attributes. The limited group of computing resource attributes includes one or more computing resource attributes in the plurality of computing resource attributes, and the limited group of computing resource attributes does not include all computing resource attributes in the plurality of computing resource attributes. The specific logic circuits are configured to cause the processor to initiate generating a configuration form describing the limited group of computing resource attributes, to initiate enabling selecting one or more computing resource attribute from the limited group of computing resource attributes, and to initiate displaying, with a video display, the configuration form. The specific logic circuits can be configured to cause the processor to initiate creating specific logic circuits configured to cause the processor to initiate displaying, with the video display: one or more descriptions of at least a portion of the plurality of computing resource attributes, one or more descriptions of one or more candidate limited groups of at least a portion of the plurality of the computing resource attributes, or a combination thereof. In an example, contents of the configuration form are dependent upon a group identifier, a logical grouping of computing resource attributes, or both. In an example, the limited group of computing resource attributes includes one or more device configuration parameters. In an example, the one or more device configuration parameters are limited to a set of options, are constrained by a minimum value, are constrained by a maximum value, include one or more regular expressions, are unconstrained, are hidden from display if the one or more device configuration parameters has a single value, are required, are optional, include an expiration date for an environment, or a practicable combination thereof. The specific logic circuits can be configured to cause the processor to initiate receiving data indicating a selection of a selected computing resource attribute from the configuration form, and to initiate adding the selected computing resource attribute to a list of selected service items. The service items include instructions configured to control a computing device. In an example, the list of selected service items includes information describing: configuration details of a server, configuration details of a virtual network, configuration details of an operating system, configuration details of software, configuration details of an object, configuration details of a cluster, configuration details of a network, a server deployment, a remote script configured to be run on a server, instructions configured to initiate deploying a pod of containers, instructions configured to initiate a networking change, instructions configured to initiate deploying a virtual network, instructions configured to initiate deploying a load balancer, instructions configured to initiate emailing a user, instructions configured to initiate coupling a virtual network to an external system, instructions configured to initiate performing an automatable operation, an internet protocol address, or a combination thereof. In an example, the data indicating the selection of the selected computing resource attribute includes data indicating a parameter value. The specific logic circuits can be configured to cause the processor to initiate creating specific logic circuits configured to cause the processor to initiate translating at least a portion of the list of selected service items to one or more respective APIs of the first platform, the second platform, or both. The APIs are configured to implement one or more selected service items in the list of selected service items. The specific logic circuits can be configured to cause the processor to initiate receiving an instruction to implement the one or more selected service items, and to initiate calling, via a communications network device, the APIs. The specific logic circuits can be configured to cause the processor to initiate receiving data indicating a deselection of a selected computing resource attribute from the configuration form, and to initiate removing the deselected service item from a list of selected service items. The specific logic circuits can be configured to cause the processor to initiate saving the limited group of computing resource attributes, to initiate retrieving the limited group of computing resource attributes from an electronic memory device, or both. The specific logic circuits can be configured to cause the processor to initiate saving the configuration form, to initiate retrieving the configuration form from an electronic memory device, or both. In an example, the configuration form is workload-specific, application-specific, or both.

The foregoing broadly outlines some of the features and technical advantages of the present teachings so the detailed description and drawings can be better understood. Additional features and advantages are also described in the detailed description. The conception and disclosed examples can be used as a basis for modifying or designing other devices for carrying out the same purposes of the present teachings. Such equivalent constructions do not depart from the technology of the teachings as set forth in the claims. The inventive features characteristic of the teachings, together with further objects and advantages, are better understood from the detailed description and the accompanying drawings. Each of the drawings is provided for the purpose of illustration and description only, and does not limit the present teachings.

### BRIEF DESCRIPTION OF THE DRAWINGS

The accompanying drawings are presented to describe examples of the present teachings, and are not limiting.

FIG. 1 depicts an example cloud computing arrangement.

FIG. 2 depicts an example computing device suitable for implementing examples of the presently disclosed subject matter.

FIGS. 3A and 3B depict an example method for generating a cloud computing configuration form.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Methods and apparatuses relating to generating a cloud computing configuration form are provided. A configuration form is generated, for example, under control of a human administrator, and can be based at least in part on computing resources available from two or more disparate computing clouds, as well as preconfiguring objects available from the two or more disparate computing clouds. A subsequent cloud user (a “user”) can select one or more preconfigured objects and a candidate cloud from the configuration form. Then, computing resource attributes are automatically determined, based on the selected cloud and the selected preconfigured objects. The computing resource attributes can be translated into application program interfaces (APIs) appropriate for the selected cloud. The APIs can be called from the selected cloud to implement the selected preconfigured objects.

Examples disclosed hereby advantageously and beneficially address long-felt industry needs, as well as other previously unidentified needs, and mitigate shortcomings of the conventional methods and conventional apparatus. Provided examples beneficially improve functioning of a computer (e.g., a platform management device) and improve an existing technological process (e.g., configuring a computing resource provided by one or more cloud computing platforms). Among other advantages, the provided examples can reduce a time required to prepare a configuration template, when compared to conventional techniques. The provided examples can also beneficially make preparing a configuration template less complicated, when compared to conventional techniques. Another advantage provided by the disclosed examples is standardizing an offering of services from multiple different clouds of computing resources, which reduces confusion and saves time. Another advantage provided by the disclosed examples is that a generated configuration form (also known as a template) enables selection of one or more objects from any cloud in multiple clouds, without a cloud computing user being required to use a different respective template for each cloud. Thus, for example, a single template can be generated and can be deployed across any of five clouds, instead of the user having to complete five different respective templates (one for each of the five clouds). In examples, implementing a single template which can be dynamically changed based on one or more target clouds for deployment can save the user's time and resources, and can ease implementation effort.

Disclosed examples also advantageously enable a configuration form to be tailored to implement corporate policy and accommodate a user's technical proficiency by injecting business logic into cloud computing implementations via a configuration form. For example, if a company requires a cloud computing user to use specific hardware, specific software, or a specific combination thereof, such as for specific workloads, specific applications, the like, or a combination thereof, the generated configuration form can specifically include the specific hardware, the specific software, or the specific combination thereof. The disclosed example methods and apparatuses also improve, for example, the technical fields of computer management, computer resource management, and cloud computing.

Examples are disclosed in this application's text and drawings. Alternate examples can be devised without departing from the scope of the disclosure. Additionally, conventional elements of the current teachings may not be described in detail, or may be omitted, to avoid obscuring aspects of the current teachings.

The following list of abbreviations, acronyms, and terms is provided to assist in comprehending the current disclosure, and are not provided as limitations.

API—application programming interface

CMDB—configuration management database

IaaS—infrastructure as a service

PaaS—platform as a service

SaaS—software as a service

Cloud computing is a model for enabling one or more cloud users (a “user”) to access a shared pool of computing resources. The computing resources can include one or more processors, one or more servers (physical, virtual, or both), one or more storage devices (for example, memory, disk storage, the like, and combinations thereof), one or more network devices, one or more networks (for example, a virtual network, including internet protocol addresses), one or more firewalls, one or more load balancers, one or more virtual machines, one or more operating systems, one or more software applications, one or more programming languages, one or more computer-based services, one or more pods of containers, one or more web servers, the like, or a combination thereof. The computing resources can be offered with a service model which best suits a user's constraints (for example, skill level, needs, ability to pay, etc.). Cloud computing often has five characteristics: on-demand self-service by one or more users, broad network access, pooled computing resources, rapid elasticity, and measured service.

Users may not own the hardware constituting a cloud or the software run on the cloud's hardware. Instead, a user can lease, from a cloud provider, at least some portion of the hardware, at least some portion of the software, or both.

Cloud computing advantageously provides an economy of scale unattainable with user-owned and maintained resources. A user need not purchase a complete set of hardware and software necessary to complete a particular task or provide a particular service. Instead, the user only pays for the user's use (that is, a utility computing basis) or the user pays a flat rate on a time-basis (for example, the user purchases use of an e-mail application for $12.00 per month). This can be analogized to the user renting the computing resources the user needs, for the duration the user needs the computing resources. Further, the cloud provider can spread demand from multiple users across one or more machines, which improves machine utilization in an economically efficient manner. Improved machine utilization reduces a number of idle machines, which saves power. Thus, computing resources are efficiently shared among many users, which results in the economy of scale, cost savings for users, profits for cloud providers, and power savings.

Cloud computing is also dynamically scalable (though not in an unlimited manner) to meet a user's timely needs (for example, pay-as-you-grow (or shrink)). A workload can be run on multiple machines (for example, physical, virtual, or both) to meet service demand. A workload can be a combination of one or more processing loads, one or more storage loads, the like, or a combination thereof. The user can thus save money which would otherwise be allocated to purchase a multitude of computing resources needed to ensure the user can meet the user's peak needs.

Cloud computing also advantageously enables the user to focus on the user's core tasks, and unburdens the user from having to purchase, configure, secure, and maintain computing resources. The user is further unburdened by not having to learn new computing skills needed to configure and maintain underlying computing resources. Many of the cloud's processes are transparent to the user. Software running on the cloud may appear, to a user, on the user's computer as if the software was installed and running locally on the user's computer. Cloud computing can present the user with a simple environment.

A cloud can be configured based on the following service models: infrastructure as a service (IaaS), platform as a service (PaaS), software as a service (SaaS), or a combination thereof. Each of these are described in turn. Note that other service models are possible; the discussion below is not meant to be limiting.

When offering IaaS, a cloud provider offers access to at least a portion of user-configurable individual components in a shared pool of computing resources. The computing resources can include one or more processors, one or more servers (physical, virtual, or both), one or more storage devices (for example, memory, disk storage, the like, and combinations thereof), one or more network devices, one or more networks (for example, including internet protocol addresses), one or more firewalls, one or more load balancers, the like, or a combination thereof.

A user of IaaS can optionally install one or more operating systems, applications, or both, of the user's choice on the user-configurable individual components. The user may be required to maintain the installed software. The user may also be required to configure each user-configurable individual component.

In IaaS, the components can be offered for use for a user-determined duration. The components can be offered on a fractional (that is, shared) access basis or an exclusive access basis. In an example, the user can be billed for specific component use or the user can be billed at a flat rate based on the components used. IaaS offers a highly technical user a high level of implementation flexibility and a high level of configuration options.

When offering PaaS, the cloud provider offers a preconfigured arrangement of components and software, where the components and software are in a shared pool of computing resources. The computing resources can include one or more processors, one or more servers (physical, virtual, or both), one or more storage devices (for example, memory, disk storage, the like, and combinations thereof), one or more network devices, one or more networks (for example, including internet protocol addresses), one or more firewalls, one or more load balancers, the like, or a combination thereof. The preconfigured software can include one or more operating systems, one or more databases, one or more programming environments, one or more runtime environments, one or more web servers, the like, or a combination thereof.

In PaaS, the components and software can be offered for use for a user-determined duration. The components and software can be offered on a fractional (that is, shared) access basis or an exclusive access basis. In an example, the user can be billed for specific component and software use or the user can be billed at a flat rate based on the components used. PaaS advantageously offers a user, who has a specific need, a quick solution to the user's needs. However, PaaS does not require the user to purchase and manually configure the underlying resources. For example, a software developer can use a PaaS-based programming environment to develop a new program, without the software developer having to purchase a development server, an operating system for the development server, and programming language software. An environment can include a group of jointly acting computing resources.

When offering SaaS, the cloud provider offers pre-installed and cloud provider-maintained application software. The user does not maintain the underlying hardware, network, database, operating system, or application. In examples, the user can access the application software from many different locations, such as via the Internet.

In an example, the user can be billed for specific software use or the user can be billed at a flat rate based on the software used. SaaS advantageously offers a user, who has a specific software need, with a quick solution to the user's needs. However, SaaS does not require the user to purchase and manually configure the underlying resources or the software. For example, a businessperson can use a SaaS web-based email program, without the businessperson having to purchase, configure, and maintain a server, an operating system for the server, and email software.

Cloud computing has several different deployment models. For example, a private cloud deployment model can be provided for exclusive use by users in an organization. As a further, example, a community cloud deployment model can be provided for use by an exclusive community of users having a common need. Moreover, a public cloud deployment model can be provided for use by anyone. Further, any of these three deployment models can be combined and implemented with technology enabling portable data, one or more portable applications, or both.

Cloud computing requires hardware, such as one or more processors, one or more servers (physical, virtual, or both), one or more storage devices (for example, memory, disk storage, the like, and combinations thereof), one or more network devices, one or more networks, the like, or a combination thereof. Configuration of the hardware can be very flexible. A first hardware component in a first cloud can be configured to be coupled to a second hardware component located in the first cloud or located in a second cloud. The first hardware component in the first cloud can be configured to be coupled to a third hardware component located remotely from the first cloud.

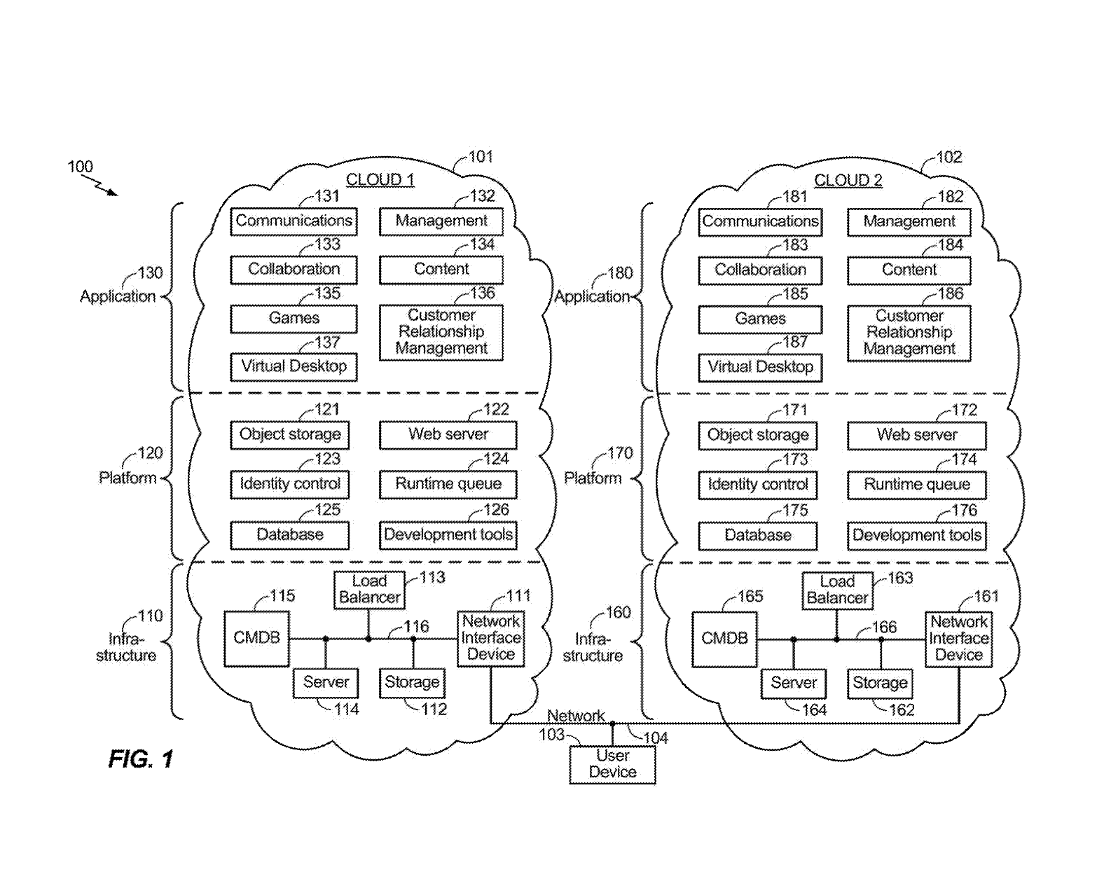

FIG. 1 depicts an example cloud computing arrangement 100 including a first cloud 101 and a second cloud 102. For example, a first cloud provider can offer the first cloud 101, while a second cloud provider offers the second cloud 102.

A user device 103 is coupled to the first cloud 101 and the second cloud 102 via one or more networks 104. The user device 103 can be a computer (for example, a desktop computer, a laptop computer, a tablet computer, the like, or a combination thereof), a mobile phone, the like, or a combination thereof. The one or more networks 104 can be a private network, a local network, a wide-area network, the Internet, any suitable communication network, the like, or a combination thereof. The one or more networks 104 can be implemented on any suitable platform including a wired network, a wireless network, an optical network, the like, or a combination thereof.

The first cloud 101 can be divided into infrastructure 110, platform 120, and one or more applications 130. The infrastructure 110 includes tangible electronic hardware. The infrastructure 110 can include one or more network interface devices 111. The one or more network interface devices 111 can be coupled to the one or more networks 104. The infrastructure 110 can include one or more storage devices 112. The one or more storage devices 112 can include one or more disk storage devices, a quantity of memories (such as random-access memory (RAM), read-only memory (ROM), flash RAM, the like, or a combination thereof), one or more solid state drives (SSD), the like, or a combination thereof. The infrastructure 110 can include one or more load balancers 113, one or more servers 114, one or more Configuration Management Databases (CMDB) 115, the like, or a combination thereof. The CMDB 115 can control and manage distributed virtual computing in the first cloud 101. The CMDB 115 stores data describing policies to be enforced across constituent data centers in the first cloud 101. The CMDB 115 can also store configuration information for instantiating workloads using one or more specific environments which are configured to use the first cloud's 101 constituent computing components (for example, computing components in the infrastructure 110). Constituent components of the infrastructure 110 can be coupled to each other via a first cloud network 116.

The platform 120 and the applications 130 include software which is configured to implement, at least in part, at least a portion of the hardware in the infrastructure 110. In an example, at least one of the platform 120 or the applications 130 can be a set of computer instructions stored on a non-transitory computer-readable storage medium which, upon execution, configure one or more processors (for example, in the server 114) to create specific logic circuits (for example, one or more tangible electronic circuits configured to perform a logical operation), thus at least temporarily converting the one or more processors into a special-purpose processor.

The platform 120 can optionally include object storage 121, one or more web servers 122, identity control 123, one or more runtime queues 124, one or more databases 125, one or more development tools 126, the like, or a combination thereof.

The applications 130 can optionally include software configured to enable communications 131, management 132, collaboration 133, content 134, one or more games 135, customer relationship management 136, one or more virtual desktops 137, the like, or a combination thereof.

The second cloud 102 can be divided into infrastructure 160, platform 170, and one or more applications 180. The infrastructure 160 includes tangible electronic hardware. The infrastructure 160 can include one or more network interface devices 161. The one or more network interface devices 161 can be coupled to the one or more networks 104. The infrastructure 160 can include one or more storage devices 162. The one or more storage devices 162 can include one or more disk storage devices, a quantity of memories (such as RAM, ROM, flash RAM, the like, or a combination thereof), one or more SSD, the like, or a combination thereof. The infrastructure 160 can include one or more load balancers 163, one or more servers 164, one or more CMDB 165, the like, or a combination thereof. The CMDB 165 can control and manage distributed virtual computing in the second cloud 102. The CMDB 165 stores data describing policies to be enforced across constituent data centers in the second cloud 102. The CMDB 165 can also store configuration information for instantiating workloads using one or more specific environments which are configured to use the second cloud's 102 constituent computing components (for example, computing components in the infrastructure 160). Constituent components of the infrastructure 160 can be coupled to each other via a first cloud network 166.

The platform 170 and the applications 180 include software which is configured to implement, at least in part, at least a portion of the hardware in the infrastructure 160. In an example, at least one of the platform 170 or the applications 180 can be a set of computer instructions stored on a non-transitory computer-readable storage medium which, upon execution, configure one or more processors (for example, in the server 164) to create specific logic circuits (for example, one or more tangible electronic circuits configured to perform a logical operation), thus at least temporarily converting the one or more processors into a special-purpose processor.

The platform 170 can optionally include object storage 171, one or more web servers 172, identity control 173, one or more runtime queues 174, one or more databases 175, one or more development tools 176, the like, or a combination thereof.

The applications 180 can optionally include software configured to enable communications 181, management 182, collaboration 183, content 184, one or more games 185, customer relationship management 186, one or more virtual desktops 187, the like, or a combination thereof.

In an example, a user can implement computing resources in a cloud (for example, the first cloud 101, the second cloud 102) by creating and instantiating one or more workloads (for example, one or more virtual machines including an operating system and user-required specific software configured to run on a specific type of server). Cloud-enabled virtualization enables the user to interact with an abstraction which takes the place of a physical system. The user can access, configure, and manage the computing resources via a cloud's respective portal, an API, the like, or a combination thereof.

Different cloud providers offer different clouds. For example, a first cloud provider can offer the first cloud 101, while a second cloud provider offers the second cloud 102. This is beneficial, as the cost for a single cloud provider to provide all conceivable computing resources is prohibitive. This also provides cloud users with more options than can be provided by a single cloud provider. Accordingly, to meet a certain need, a user may want to implement a collection of computing resources which includes computing resources in disparate clouds. For example, the user may need to implement a collection of computing resources including a first computing resource which is available in the first cloud 101 and not available in the second cloud 102. The user's collection of computing resources may also include a second computing resource which is available in the second cloud 102 and not available in the first cloud 101. The first and second computing resources likely will have different, and possibly incompatible, respective APIs. The provided apparatus and methods enable the user to manage implementing different computing resources which are different parts of different clouds.

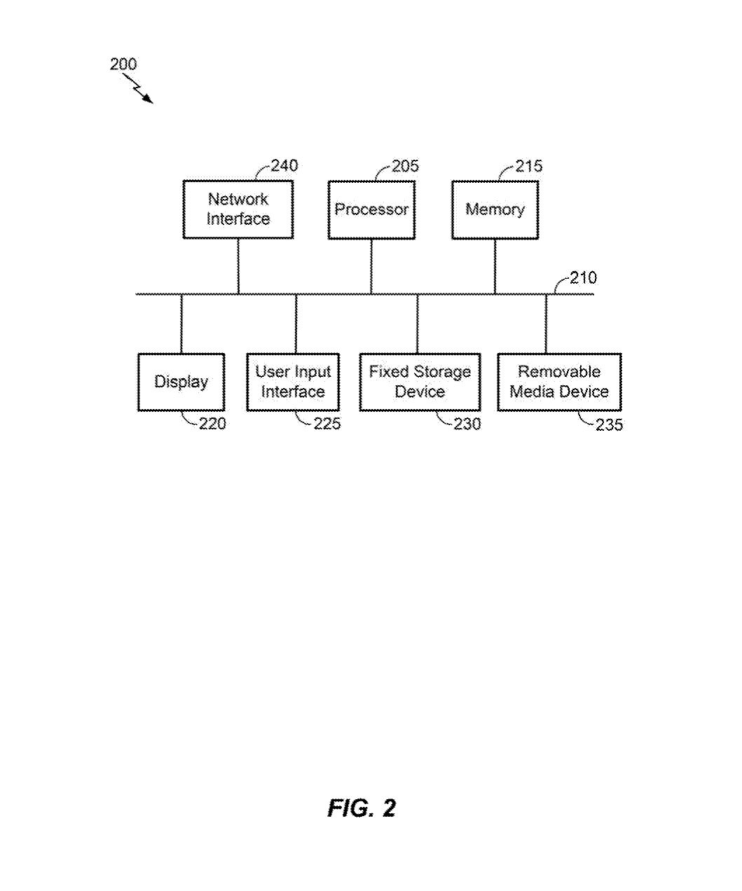

FIG. 2 illustrates an example computing device 200 suitable for implementing examples of the presently disclosed subject matter. In an example, the computing device 200 can be the user device 103. At least a portion of the methods, sequences, algorithms, steps, or blocks described in connection with the examples disclosed hereby can be embodied directly in hardware, in software executed by a processor (for example, a processor described hereby), or in a combination of the two. In an example, a processor includes multiple discrete hardware components. A software module can reside in a storage medium (for example, a memory device), such as a RAM, a flash memory, a ROM, an erasable programmable read-only memory (EPROM), an electrically erasable programmable read-only memory (EEPROM), a register, a hard disk, a removable disk, a compact disc read-only memory (CD-ROM), a storage medium, the like, or a combination thereof. An example storage medium (for example, a memory device) can be coupled to the processor so the processor can read information from the storage medium, write information to the storage medium, or both. In an example, the storage medium can be integral with the processor.

Further, examples provided hereby are described in terms of sequences of actions to be performed by, for example, one or more elements of a computing device. The actions described hereby can be performed by a specific circuit (for example, an application specific integrated circuit (ASIC)), by program instructions being executed by one or more processors, or by a combination of both. Additionally, a sequence of actions described hereby can be entirely within any form of non-transitory computer-readable storage medium having stored thereby a corresponding set of computer instructions which, upon execution, cause an associated processor (such as a special-purpose processor) to perform at least a portion of a method, a sequence, an algorithm, a step, or a block described hereby. Performing at least a part of a function described hereby can include initiating at least a part of a function described hereby, at least a part of a method described hereby, the like, or a combination thereof. In an example, execution of the stored instructions can transform a processor and any other cooperating devices into at least a part of an apparatus described hereby. A non-transitory (that is, a non-transient) machine-readable media specifically excludes a transitory propagating signal. Additionally, a sequence of actions described hereby can be entirely within any form of non-transitory computer-readable storage medium having stored thereby a corresponding set of computer instructions which, upon execution, configure the processor to create specific logic circuits (for example, one or more tangible electronic circuits configured to perform a logical operation) in the processor. Configuring the processor to create specific logic circuits in the processor can at least temporarily transform the processor into a specific-purpose processor. Thus, examples may be in a number of different forms, all of which have been contemplated to be within the scope of the disclosure.

In an example, when a general-purpose computer (for example, a processor) is configured to perform at least a portion of a method described hereby, then the general-purpose computer becomes a special-purpose computer which is not generic and is not a general-purpose computer. In an example, loading a general-purpose computer with special programming can cause the general-purpose computer to be configured to perform at least a portion of a method, a sequence, an algorithm, a step, or a block described in connection with an example disclosed hereby. Special programming can constitute any software which can cause a computer (for example, a general-purpose computer, a special-purpose computer, etc.) to be configured to perform one or more functions, features, steps algorithms, blocks, or a combination thereof, as disclosed hereby. A sufficient algorithm can constitute special programming. In an example, a combination of two or more related method steps disclosed hereby can form a sufficient algorithm.

The computing device 200 can be, for example, a desktop computer, a laptop computer, a mobile device, the like, or a combination thereof. The computing device 200 can include a processor 205, a bus 210, a memory 215 (such as RAM, ROM, flash RAM, the like, or a combination thereof), a video display 220 (such as a display screen), a user input interface 225 (which can include one or more controllers and associated user input devices such as a keyboard, mouse, touch screen, the like, or a combination thereof), a fixed storage device 230 (such as a hard drive, flash storage, the like, or a combination thereof), a removable media device 235 (operative to control and receive an optical disk, flash drive, the like, or a combination thereof), a network interface 240 operable to communicate with one or more remote devices via a suitable network connection, or a combination thereof. Examples of the disclosed subject matter can be implemented in, and used with, different component and network architectures.

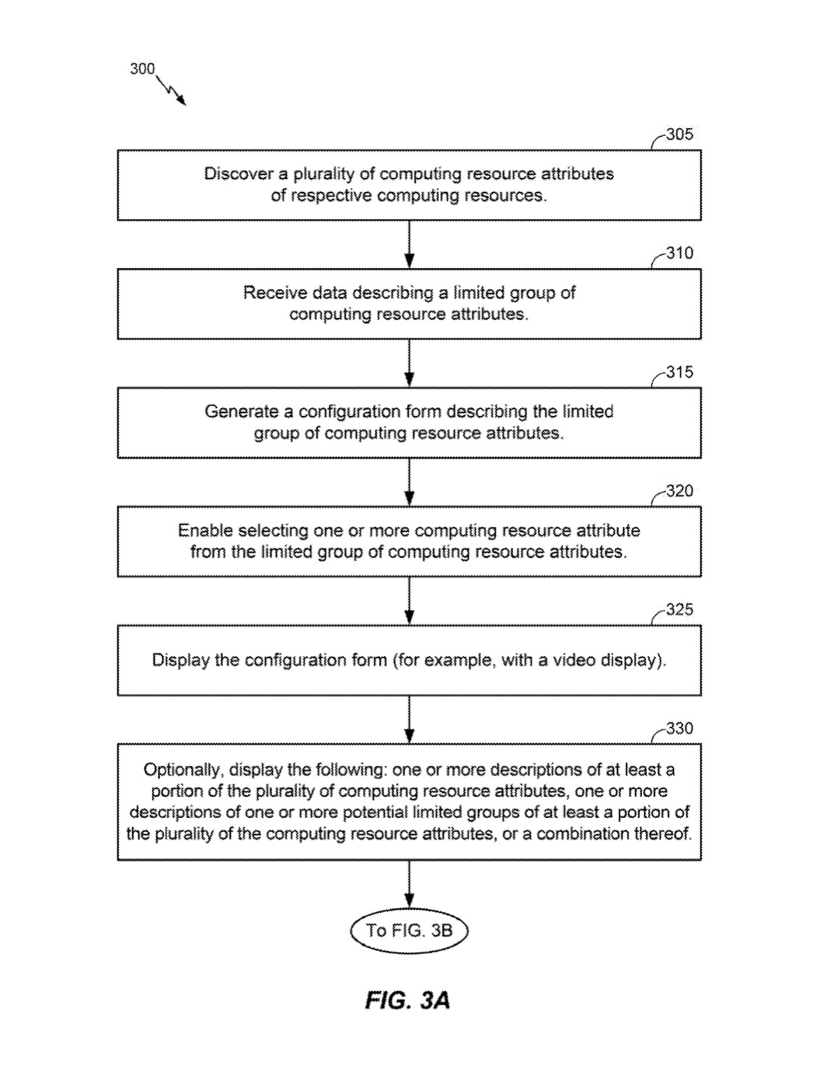

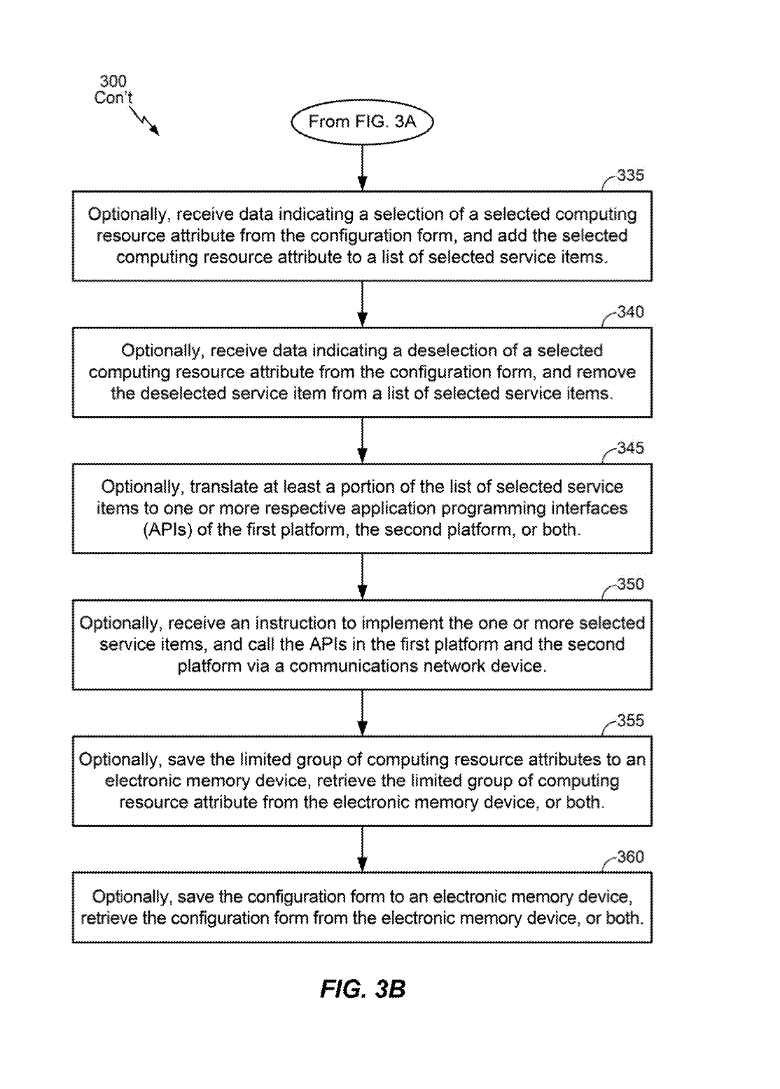

The processor 205 is configured to control operation of the user device 200, including performing at least a part of a method described hereby. The processor 205 can perform logical and arithmetic operations based on processor-executable instructions stored within the memory 215. The processor 205 can execute instructions stored in the memory 215 to implement at least a part of a method described herein (for example, the processing illustrated in FIGS. 3A to 3B). The instructions, when executed by the processor 205, can transform the processor 205 into a special-purpose processor which causes the processor to perform at least a part of a function described hereby.

The processor 205 can comprise or be a component of a processing system implemented with one or more processors. The one or more processors can be implemented with a microprocessor, a microcontroller, a digital signal processor, a field programmable gate array (FPGA), a programmable logic device (PLD), an ASIC, a controller, a state machine, gated logic, a discrete hardware component, a dedicated hardware finite state machine, any other suitable entity which can at least one of manipulate information (for example, calculating, logical operations, and the like), control another device, the like, or a combination thereof. The processor 205 may also be referred to as a central processing unit (CPU), a special-purpose processor, or both.

The bus 210 interconnects components of the computing device 200. The bus 210 can enable information communication between the processor 205 and one or more components coupled to the processor 205. The bus system 210 can include a data bus, a power bus, a control signal bus, a status signal bus, the like, or a combination thereof. The components of the computing device 200 can be coupled together to communicate with each other using a different suitable mechanism.

The memory 215, can include at least one of ROM, RAM, a flash memory, an EPROM, an EEPROM, a register, other memory, the like, or a combination thereof stores information (for example, data, instructions, software, the like, or a combination thereof) and is configured to provide the information to the processor 205. The RAM can be a main memory configured to store an operating system, an application program, the like, or a combination thereof. The ROM (for example, a flash memory) can be configured to store a basic input-output system (BIOS) which can control basic hardware operation such as the processor's 205 interaction with peripheral components. The memory 215 can also include a non-transitory machine-readable media configured to store software. Software can mean any type of instructions, whether referred to as at least one of software, firmware, middleware, microcode, hardware description language, the like, or a combination thereof. Instructions can include code (for example, in source code format, in binary code format, executable code format, or in any other suitable code format). The memory 215 is an example of an electronic memory device.

The video display 220 can include a component configured to visually convey information to a user of the computing device 200.

The user input interface 225 can include a keypad, a microphone, a speaker, a display, the like, or a combination thereof. The user input interface 225 can include a component configured to convey information to a user of the computing device 200, receive information from the user of the computing device 200, or both.

The fixed storage device 230 can be integral with the computing device 200 or can be separate and accessed through other interfaces. The fixed storage device 230 can be an information storage device which is not configured to be removed during use, such as a hard disk drive.

The removable media device 235 can be integral with the computing device 200 or can be separate and accessed through other interfaces. The removable media device 235 can be an information storage device which is configured to be removed during use, such as a memory card, a jump drive, flash memory, the like, or a combination thereof. Code to implement the present disclosure can be stored in computer-readable storage media such as one or more of the memory 215, the fixed storage device 230, the removable media device 235, a remote storage location, the like, or a combination thereof.

The network interface 240 can electrically couple the computing device 200 to a network and enable exchange of information between the computing device 200 and the network. The network, in turn, can couple the computing device 200 to another electronic device, such as a remote server, a remote storage medium, the like, or a combination thereof. The network can enable exchange of information between the computing device 200 and the electronic device.

The network interface 240 can provide coupling (for example, to the network 104) via a wired connection, a wireless connection, or a combination thereof. The network interface 240 can provide such connection using any suitable technique and protocol as is readily understood by one of skill in the art. Example techniques and protocols include digital cellular telephone, WiFi™, Bluetooth®, near-field communications (NFC), the like, and combinations thereof. For example, the network interface 240 can enable the computing device 200 to communicate with other computers (for example, the first cloud 101 and the second cloud 102) via one or more local, wide-area, or other communication networks. Other devices or components (not shown in FIG. 2) can be coupled via the network interface 240.

All of the components illustrated in FIG. 2 need not be present to practice the present disclosure. Further, the components can be interconnected in different ways from that illustrated.

FIGS. 3A and 3B depict an example method 300 for generating a cloud computing configuration form, which can be performed at least in part by at least a portion of the apparatus described hereby, such as the user device 103, the computing device 200, the like, or a combination thereof. The method 300 can reduce a time required to prepare a configuration template, when compared to conventional techniques. The method 300 can also beneficially make preparing a configuration template less complicated, when compared to conventional techniques. A platform management device which is configured to perform at least a portion of the method 300 has improved functions, relative to conventional techniques and devices.

The following example is provided as an introduction to the method 300. An information technology administrator can require that a preconfigured database server be configured with 2 CPU's and 4 GB of RAM, with 100 GB of disk space. When the cloud user wants to deploy the database server, the user inputs data indicating the database server is at least a part of a selected workload. The cloud user also inputs data indicating a selected cloud. When deploying this database server, native data formats and templates required by different clouds can differ significantly. Further, cloud providers can require that configurations be submitted in the cloud provider's respective native format. The provided methods and apparatus dynamically generate the appropriate computing resource attributes required by the target cloud's native format, based on the received data indicating the selected cloud and the received data the database server is at least the part of the selected workload. The computing resource attributes can then be translated to one or more respective APIs of the selected cloud. The APIs are configured to implement the database server as at least the part of the selected workload. The APIs in the selected cloud can then be called to implement the database server.

In block 305, a plurality of computing resource attributes of respective computing resources are discovered. The computing resources are available from at least one of a first platform and a second platform. The terms platform and cloud are used interchangeably hereby.

In block 310, one or more objects are preconfigured. In block 310, data describing a limited group of computing resource attributes is received. The limited group of computing resource attributes includes one or more computing resource attributes in the plurality of computing resource attributes, and the limited group of computing resource attributes does not include all computing resource attributes in the plurality of computing resource attributes. The limited group of computing resource attributes can include one or more device configuration parameters. The one or more device configuration parameters can be limited to a set of options, are constrained by a minimum value, are constrained by a maximum value, include one or more regular expressions, are unconstrained, are hidden from display if the one or more device configuration parameters has a single value, are required, are optional, include an expiration date for an environment, or a practicable combination thereof.

In block 315, a configuration form describing the limited group of computing resource attributes (that is, the one or more preconfigured objects) is generated. The limited group of computing resource attributes can be workload-specific, application-specific, or both. In other words, one or more specific workloads, one or more specific applications, the like, or a combination thereof can be identified, and can serve as a basis for determining which computing resources are required to implement the one or more specific workloads, the one or more specific applications, the like, or the combination thereof. Further, respective computing resource attributes of the required computing resources can be identified and added to the limited group of computing resource attributes. Thus, the configuration form can be workload-specific, application-specific, or both by including preconfigured options offered to a cloud user. Offering preconfigured options simplifies the ordering process for the user. For example, the configuration form can include a preconfiguration called “Server Size” with preconfigured options of “small,” “medium,” and “large” which describe particular respective combinations of memory size, number of CPUs, and disk size values. As a further example, availability of a preconfigured object to a specific user can be dependent upon a group identifier, the logical grouping of computing resource attributes, or both. A group identifier identifies a classification of users (for example, an administrator group, a specific group of users, or the like).

In block 320, selecting one or more computing resource attribute from the limited group of computing resource attributes is enabled.

In block 325, the configuration form is displayed (for example, with a video display).

In optional block 330, the following is displayed (for example, with the video display): one or more descriptions of at least a portion of the plurality of computing resource attributes, one or more descriptions of one or more candidate limited groups of at least a portion of the plurality of the computing resource attributes, or a combination thereof.

In optional block 335, data indicating a selection of a selected computing resource attribute from the configuration form is received. For example, the data indicating the selection of the selected computing resource attribute is a selection, by a user, of a preconfigured object. The selected computing resource attribute is added to a list of selected service items. The data indicating the selection of the selected computing resource attribute can include data indicating a parameter value. In an example, the user can select one or more preconfigured workloads, one or more preconfigured applications, the like, or a combination thereof, and computing resource attributes associated with the selected one or more preconfigured workloads, one or more pre preconfigured applications, the like, or the combination thereof are added to the list of selected service items.

The service items include instructions configured to control a computing device. The list of selected service items can include information describing: configuration details of a server, configuration details of a virtual network, configuration details of an operating system, configuration details of software, configuration details of an object, configuration details of a cluster, configuration details of a network, a server deployment, a remote script configured to be run on a server, instructions configured to initiate deploying a pod of containers, instructions configured to initiate a networking change, instructions configured to initiate deploying a virtual network, instructions configured to initiate deploying a load balancer, instructions configured to initiate emailing a user, instructions configured to initiate coupling a virtual network to an external system, instructions configured to initiate performing an automatable operation, an internet protocol address, or a combination thereof.

In optional block 340, data indicating a deselection of a selected computing resource attribute from the configuration form is received. The deselected service item is removed from a list of selected service items.

In optional block 345, at least a portion of the list of selected service items is translated to one or more respective APIs. For example, the at least a portion of the list of selected service items is translated to one or more respective APIs of the first platform, the second platform, or both. The APIs are configured to implement one or more selected service items in the list of selected service items.

In optional block 350, an instruction to implement the one or more selected service items is received, and the APIs are called via a communications network device. The APIs can be called from the selected computing cloud, such as the first platform or the second platform.

In optional block 355, the limited group of computing resource attributes is saved to an electronic memory device, the limited group of computing resource attributes is retrieved from the electronic memory device, or both.

In optional block 360, the configuration form is saved to an electronic memory device, the configuration form is retrieved from the electronic memory device, or both.

The foregoing blocks are not limiting of the examples. The blocks can be combined and/or the order can be rearranged, as practicable.

As used hereby, the term “example” means “serving as an example, instance, or illustration.” Any example described as an “example” is not necessarily to be construed as preferred or advantageous over other examples. Likewise, the term “examples” does not require all examples include the discussed feature, advantage, or mode of operation. Use of the terms “in one example,” “an example,” “in one feature,” and/or “a feature” in this specification does not necessarily refer to the same feature and/or example. Furthermore, a particular feature and/or structure can be combined with one or more other features and/or structures. Moreover, at least a portion of the apparatus described hereby can be configured to perform at least a portion of a method described hereby.

It should be noted the terms “connected,” “coupled,” and any variant thereof, mean any connection or coupling between elements, either direct or indirect, and can encompass a presence of an intermediate element between two elements which are “connected” or “coupled” together via the intermediate element. Coupling and connection between the elements can be physical, logical, or a combination thereof. Elements can be “connected” or “coupled” together, for example, by using one or more wires, cables, printed electrical connections, electromagnetic energy, and the like. The electromagnetic energy can have a wavelength at a radio frequency, a microwave frequency, a visible optical frequency, an invisible optical frequency, and the like, as practicable. These are several non-limiting and non-exhaustive examples.

The term “signal” can include any signal such as a data signal, an audio signal, a video signal, a multimedia signal, an analog signal, a digital signal, and the like. Information and signals described hereby can be represented using any of a variety of different technologies and techniques. For example, data, an instruction, a process step, a process block, a command, information, a signal, a bit, a symbol, and the like which are referred to hereby can be represented by a voltage, a current, an electromagnetic wave, a magnetic field, a magnetic particle, an optical field, an optical particle, and/or any practical combination thereof, depending at least in part on the particular application, at least in part on the desired design, at least in part on the corresponding technology, and/or at least in part on like factors.

A reference using a designation such as “first,” “second,” and so forth does not limit either the quantity or the order of those elements. Rather, these designations are used as a convenient method of distinguishing between two or more elements or instances of an element. Thus, a reference to first and second elements does not mean only two elements can be employed, or the first element must necessarily precede the second element. Also, unless stated otherwise, a set of elements can comprise one or more elements. In addition, terminology of the form “at least one of: A, B, or C” or “one or more of A, B, or C” or “at least one of the group consisting of A, B, and C” used in the description or the claims can be interpreted as “A or B or C or any combination of these elements.” For example, this terminology can include A, or B, or C, or A and B, or A and C, or A and B and C, or 2A, or 2B, or 2C, and so on.

The terminology used hereby is for the purpose of describing particular examples only and is not intended to be limiting. As used hereby, the singular forms “a,” “an,” and “the” include the plural forms as well, unless the context clearly indicates otherwise. In other words, the singular portends the plural, where practicable. Further, the terms “comprises,” “comprising,” “includes,” and “including,” specify a presence of a feature, an integer, a step, a block, an operation, an element, a component, and the like, but do not necessarily preclude a presence or an addition of another feature, integer, step, block, operation, element, component, and the like.

Those of skill in the art will appreciate the example logical blocks, modules, circuits, and steps described in the examples disclosed hereby can be implemented as electronic hardware, computer software, or combinations of both, as practicable. To clearly illustrate this interchangeability of hardware and software, example components, blocks, modules, circuits, and steps have been described hereby generally in terms of their functionality. Whether such functionality is implemented as hardware or software depends upon the particular application and design constraints imposed on an overall system. Skilled artisans can implement the described functionality in different ways for each particular application, but such implementation decisions should not be interpreted as causing a departure from the scope of the present disclosure. In addition, for each of the examples described hereby, a corresponding electrical circuit of any such examples may be described hereby as, for example, “logic configured to” perform a described action.

At least one example provided hereby can include a non-transitory (that is, a non-transient) machine-readable media and/or a non-transitory (that is, a non-transient) computer-readable media storing processor-executable instructions (e.g., “code”) configured to cause a processor (for example, a special-purpose processor) to transform the processor and any other cooperating devices into a machine (for example, a special-purpose processor) configured to perform at least a part of a function described hereby, at least a part of a method described hereby, the like, or a combination thereof. Performing the at least a part of a function described hereby can include initiating at least a part of the function described hereby. Performing the at least a part of a method described hereby can include initiating at least a part of the method described hereby. In an example, execution of the stored instructions can transform a processor and any other cooperating devices into at least a part of an apparatus described hereby. A non-transitory (that is, a non-transient) machine-readable media specifically excludes a transitory propagating signal. Further, one or more embodiments can include a computer-readable medium embodying at least a part of a function described hereby, at least a part of a method described hereby, the like, or a combination thereof.

Nothing stated or depicted in this application is intended to dedicate any component, step, block, feature, object, benefit, advantage, or equivalent to the public, regardless of whether the component, step, block, feature, object, benefit, advantage, or the equivalent is recited in the claims. While this disclosure describes examples, changes and modifications can be made to the examples disclosed hereby without departing from the scope defined by the appended claims. The present disclosure is not intended to be limited to the specifically disclosed examples alone.

What is claimed is:

1. A method, comprising:
discovering a plurality of computing resource attributes of respective computing resources, wherein the computing resources are available from at least one of a first platform and a second platform;
receiving data describing a limited group of computing resource attributes, wherein the limited group of computing resource attributes includes one or more computing resource attributes in the plurality of computing resource attributes, and the limited group of computing resource attributes does not include all computing resource attributes in the plurality of computing resource attributes;
generating a configuration form describing the limited group of computing resource attributes;
enabling selecting one or more computing resource attribute from the limited group of computing resource attributes; and
displaying, with a video display, the configuration form.

2. The method of claim 1, further comprising displaying, with the video display:
one or more descriptions of at least a portion of the plurality of computing resource attributes,
one or more descriptions of one or more candidate limited groups of at least a portion of the plurality of the computing resource attributes, or
a combination thereof.

3. The method of claim 1, wherein contents of the configuration form are dependent upon a group identifier, a logical grouping of computing resource attributes, or both.

4. The method of claim 1, wherein the limited group of computing resource attributes includes one or more device configuration parameters.

5. The method of claim 4, wherein the one or more device configuration parameters are limited to a set of options, are constrained by a minimum value, are constrained by a maximum value, include one or more regular expressions, are unconstrained, are hidden from display if the one or more device configuration parameters has a single value, are required, are optional, include an expiration date for an environment, or a practicable combination thereof.

6. The method of claim 1, further comprising:
receiving data indicating a selection of a selected computing resource attribute from the configuration form; and
adding the selected computing resource attribute to a list of selected service items, wherein the service items include instructions configured to control a computing device.

7. The method of claim 6, wherein the list of selected service items includes information describing: configuration details of a server, configuration details of a virtual network, configuration details of an operating system, configuration details of software, configuration details of an object, configuration details of a cluster, configuration details of a network, a server deployment, a remote script configured to be run on a server, instructions configured to initiate deploying a pod of containers, instructions configured to initiate a networking change, instructions configured to initiate deploying a virtual network, instructions configured to initiate deploying a load balancer, instructions configured to initiate emailing a user, instructions configured to initiate coupling a virtual network to an external system, instructions configured to initiate performing an automatable operation, an internet protocol address, or a combination thereof.

8. The method of claim 7, wherein the data indicating the selection of the selected computing resource attribute includes data indicating a parameter value.

9. The method of claim 1, further comprising translating at least a portion of the list of selected service items to one or more respective application programming interfaces (APIs) of the first platform, the second platform, or both, wherein the APIs are configured to implement one or more selected service items in the list of selected service items.

10. The method of claim 9, further comprising:
receiving an instruction to implement the one or more selected service items; and
calling, via a communications network device, the APIs.

11. The method of claim 1, further comprising:
receiving data indicating a deselection of a selected computing resource attribute from the configuration form; and
removing the deselected service item from a list of selected service items.

12. The method of claim 1, further comprising:
saving the limited group of computing resource attributes;
retrieving the limited group of computing resource attributes from an electronic memory device; or
both.

13. The method of claim 1, further comprising:
saving the configuration form;
retrieving the configuration form from an electronic memory device; or
both.

14. The method of claim 1, wherein the configuration form is workload-specific, application-specific, or both.

15. An apparatus, comprising:
means for discovering a plurality of computing resource attributes of respective computing resources, wherein the computing resources are available from at least one of a first platform and a second platform;
means for receiving data describing a limited group of computing resource attributes, wherein the limited group of computing resource attributes includes one or more computing resource attributes in the plurality of computing resource attributes, and the limited group of computing resource attributes does not include all computing resource attributes in the plurality of computing resource attributes;
means for generating a configuration form describing the limited group of computing resource attributes;
means for enabling selecting one or more computing resource attribute from the limited group of computing resource attributes; and
means for displaying, with a video display, the configuration form.

16. The apparatus of claim 15, further comprising means for displaying, with the video display:
one or more descriptions of at least a portion of the plurality of computing resource attributes,
one or more descriptions of one or more candidate limited groups of at least a portion of the plurality of the computing resource attributes, or
a combination thereof.

17. The apparatus of claim 15, wherein contents of the configuration form are dependent upon a group identifier, a logical grouping of computing resource attributes, or both.

18. The apparatus of claim 15, wherein the limited group of computing resource attributes includes one or more device configuration parameters.

19. The apparatus of claim 18, wherein the one or more device configuration parameters are limited to a set of options, are constrained by a minimum value, are constrained by a maximum value, include one or more regular expressions, are unconstrained, are hidden from display if the one or more device configuration parameters has a single value, are required, are optional, include an expiration date for an environment, or a practicable combination thereof.

20. The apparatus of claim 15, further comprising:
means for receiving data indicating a selection of a selected computing resource attribute from the configuration form; and
means for adding the selected computing resource attribute to a list of selected service items, wherein the service items include instructions configured to control a computing device.

21. The apparatus of claim 20, wherein the list of selected service items includes information describing: configuration details of a server, configuration details of a virtual network, configuration details of an operating system, configuration details of software, configuration details of an object, configuration details of a cluster, configuration details of a network, a server deployment, a remote script configured to be run on a server, instructions configured to initiate deploying a pod of containers, instructions configured to initiate a networking change, instructions configured to initiate deploying a virtual network, instructions configured to initiate deploying a load balancer, instructions configured to initiate emailing a user, instructions configured to initiate coupling a virtual network to an external system, instructions configured to initiate performing an automatable operation, an internet protocol address, or a combination thereof.

22. The apparatus of claim 21, wherein the data indicating the selection of the selected computing resource attribute includes data indicating a parameter value.

23. The apparatus of claim 15, further comprising means for translating at least a portion of the list of selected service items to one or more respective application programming interfaces (APIs) of the first platform, the second platform, or both, wherein the APIs are configured to implement one or more selected service items in the list of selected service items.

24. The apparatus of claim 23, further comprising:
means for receiving an instruction to implement the one or more selected service items; and
means for calling, via a communications network device, the APIs.

25. The apparatus of claim 15, further comprising:
means for receiving data indicating a deselection of a selected computing resource attribute from the configuration form; and
means for removing the deselected service item from a list of selected service items.

26. The apparatus of claim 15, further comprising:
means for saving the limited group of computing resource attributes;
means for retrieving the limited group of computing resource attributes from an electronic memory device; or
both.

27. The apparatus of claim 15, further comprising:
means for saving the configuration form;
means for retrieving the configuration form from an electronic memory device; or
both.

28. The apparatus of claim 15, wherein the configuration form is workload-specific, application-specific, or both.

29. An apparatus, comprising:
a processor; and
a memory coupled to the processor and configured to cause the processor to initiate creating specific logic circuits within the processor, wherein the specific logic circuits are configured to cause the processor to initiate:
discovering a plurality of computing resource attributes of respective computing resources, wherein the computing resources are available from at least one of a first platform and a second platform;
receiving data describing a limited group of computing resource attributes, wherein the limited group of computing resource attributes includes one or more computing resource attributes in the plurality of computing resource attributes, and the limited group of computing resource attributes does not include all computing resource attributes in the plurality of computing resource attributes;
generating a configuration form describing the limited group of computing resource attributes;
enabling selecting one or more computing resource attribute from the limited group of computing resource attributes; and
displaying, with a video display, the configuration form.

30. The apparatus of claim 29, wherein the memory is configured to cause the processor to initiate creating specific logic circuits configured to cause the processor to initiate displaying, with the video display:
one or more descriptions of at least a portion of the plurality of computing resource attributes,
one or more descriptions of one or more candidate limited groups of at least a portion of the plurality of the computing resource attributes, or
a combination thereof.

31. The apparatus of claim 29, wherein contents of the configuration form are dependent upon a group identifier, a logical grouping of computing resource attributes, or both.

32. The apparatus of claim 29, wherein the limited group of computing resource attributes includes one or more device configuration parameters.

33. The apparatus of claim 32, wherein the one or more device configuration parameters are limited to a set of options, are constrained by a minimum value, are constrained by a maximum value, include one or more regular expressions, are unconstrained, are hidden from display if the one or more device configuration parameters has a single value, are required, are optional, include an expiration date for an environment, or a practicable combination thereof.

34. The apparatus of claim 29, wherein the memory is configured to cause the processor to initiate creating specific logic circuits configured to cause the processor to initiate:
receiving data indicating a selection of a selected computing resource attribute from the configuration form; and
adding the selected computing resource attribute to a list of selected service items, wherein the service items include instructions configured to control a computing device.

35. The apparatus of claim 34, wherein the list of selected service items includes information describing: configuration details of a server, configuration details of a virtual network, configuration details of an operating system, configuration details of software, configuration details of an object, configuration details of a cluster, configuration details of a network, a server deployment, a remote script configured to be run on a server, instructions configured to initiate deploying a pod of containers, instructions configured to initiate a networking change, instructions configured to initiate deploying a virtual network, instructions configured to initiate deploying a load balancer, instructions configured to initiate emailing a user, instructions configured to initiate coupling a virtual network to an external system, instructions configured to initiate performing an automatable operation, an internet protocol address, or a combination thereof.

36. The apparatus of claim 35, wherein the data indicating the selection of the selected computing resource attribute includes data indicating a parameter value.

37. The apparatus of claim 29, wherein the memory is configured to cause the processor to initiate creating specific logic circuits configured to cause the processor to initiate translating at least a portion of the list of selected service items to one or more respective application programming interfaces (APIs) of the first platform, the second platform, or both, wherein the APIs are configured to implement one or more selected service items in the list of selected service items.

38. The apparatus of claim 37, wherein the memory is configured to cause the processor to initiate creating specific logic circuits configured to cause the processor to initiate:
receiving an instruction to implement the one or more selected service items; and
calling, via a communications network device, the APIs.

39. The apparatus of claim 29, wherein the memory is configured to cause the processor to initiate creating specific logic circuits configured to cause the processor to initiate:
receiving data indicating a deselection of a selected computing resource attribute from the configuration form; and
removing the deselected service item from a list of selected service items.

40. The apparatus of claim 29, wherein the memory is configured to cause the processor to initiate creating specific logic circuits configured to cause the processor to initiate:
saving the limited group of computing resource attributes;
retrieving the limited group of computing resource attributes from an electronic memory device; or
both.

41. The apparatus of claim 29, wherein the memory is configured to cause the processor to initiate creating specific logic circuits configured to cause the processor to initiate:
saving the configuration form;
retrieving the configuration form from an electronic memory device; or
both.

42. The apparatus of claim 29, wherein the configuration form is workload-specific, application-specific, or both.

43. A non-transitory computer-readable medium, comprising:
processor-executable instructions stored thereon configured to cause a processor to initiate:
discovering a plurality of computing resource attributes of respective computing resources, wherein the computing resources are available from at least one of a first platform and a second platform;
receiving data describing a limited group of computing resource attributes, wherein the limited group of computing resource attributes includes one or more computing resource attributes in the plurality of computing resource attributes, and the limited group of computing resource attributes does not include all computing resource attributes in the plurality of computing resource attributes;
generating a configuration form describing the limited group of computing resource attributes;
enabling selecting one or more computing resource attribute from the limited group of computing resource attributes; and
displaying, with a video display, the configuration form.

44. The non-transitory computer-readable medium of claim 43, wherein the processor-executable instructions further include instructions configured to cause the processor to initiate displaying, with the video display:
one or more descriptions of at least a portion of the plurality of computing resource attributes,
one or more descriptions of one or more candidate limited groups of at least a portion of the plurality of the computing resource attributes, or
a combination thereof.

45. The non-transitory computer-readable medium of claim 43, wherein contents of the configuration form are dependent upon a group identifier, a logical grouping of computing resource attributes, or both.

46. The non-transitory computer-readable medium of claim 43, wherein the limited group of computing resource attributes includes one or more device configuration parameters.

47. The non-transitory computer-readable medium of claim 46, wherein the one or more device configuration parameters are limited to a set of options, are constrained by a minimum value, are constrained by a maximum value, include one or more regular expressions, are unconstrained, are hidden from display if the one or more device configuration parameters has a single value, are required, are optional, include an expiration date for an environment, or a practicable combination thereof.

48. The non-transitory computer-readable medium of claim 43, wherein the processor-executable instructions further include instructions configured to cause the processor to initiate:
receiving data indicating a selection of a selected computing resource attribute from the configuration form; and
adding the selected computing resource attribute to a list of selected service items, wherein the service items include instructions configured to control a computing device.

49. The non-transitory computer-readable medium of claim 48, wherein the list of selected service items includes information describing: configuration details of a server, configuration details of a virtual network, configuration details of an operating system, configuration details of software, configuration details of an object, configuration details of a cluster, configuration details of a network, a server deployment, a remote script configured to be run on a server, instructions configured to initiate deploying a pod of containers, instructions configured to initiate a networking change, instructions configured to initiate deploying a virtual network, instructions configured to initiate deploying a load balancer, instructions configured to initiate emailing a user, instructions configured to initiate coupling a virtual network to an external system, instructions configured to initiate performing an automatable operation, an internet protocol address, or a combination thereof.

50. The non-transitory computer-readable medium of claim 49, wherein the data indicating the selection of the selected computing resource attribute includes data indicating a parameter value.

51. The non-transitory computer-readable medium of claim 43, wherein the processor-executable instructions further include instructions configured to cause the processor to initiate translating at least a portion of the list of selected service items to one or more respective application programming interfaces (APIs) of the first platform, the second platform, or both, wherein the APIs are configured to implement one or more selected service items in the list of selected service items.

52. The non-transitory computer-readable medium of claim 51, wherein the processor-executable instructions further include instructions configured to cause the processor to initiate:
receiving an instruction to implement the one or more selected service items; and
calling, via a communications network device, the APIs.

53. The non-transitory computer-readable medium of claim 51, wherein the processor-executable instructions further include instructions configured to cause the processor to initiate:
receiving data indicating a deselection of a selected computing resource attribute from the configuration form; and
removing the deselected service item from a list of selected service items.

54. The non-transitory computer-readable medium of claim 51, wherein the processor-executable instructions further include instructions configured to cause the processor to initiate:
saving the limited group of computing resource attributes;
retrieving the limited group of computing resource attributes from an electronic memory device; or
both.

55. The non-transitory computer-readable medium of claim 51, wherein the processor-executable instructions further include instructions configured to cause the processor to initiate:
saving the configuration form;
retrieving the configuration form from an electronic memory device; or
both.

56. The non-transitory computer-readable medium of claim 51, wherein the configuration form is workload-specific, application-specific, or both.
